(19) United States
(12) Patent Application Publication
(10) Pub. No.: US 2016/0279777 A1
(43) Pub. Date: Sep. 29, 2016

(54) Modified Ball Peen Tool For Air Hammer

(71) Applicant: David Alan Camp, Cumming, GA (US)

(72) Inventor: David Alan Camp, Cumming, GA (US)

(21) Appl. No.: 14/666,455

(22) Filed: Mar. 24, 2015

(51) Int. Cl. B25D 17/02

(52) U.S. Cl. CPC B25D 17/02

(57) ABSTRACT

A tool for an air hammer uses a ball peen striking head having a machined striking surface to concentrate impact forces on a defined area while reducing slippage of the striking surface from the target area.

### FIELD OF INVENTION

The present invention relates to a ball peen tool for an air hammer. In even greater particularity the present invention relates to a ball peen hammer with a reduced striking area and increased head mass that can be used in a standard air hammer to reach locations that are not easily reached by a flat faced hammer.

### BACKGROUND

The present invention is an improvement over flat faced hammers which apply force across a broader area and are prone to slippage from the desired work area. The ball peen design allows a more concentrated contact point with less propensity for slippage. Therefore applying more impact force to the targeted area. This is particularly important when working in tight spaces such as disassembling used automobiles where access to the connectors holding the parts together may be cumbersome or limited. Traditional hand held ball peen hammers are used for shaping metal and tempering metal and have a hemispheric peen on one or more side of the handle. A fully hemispheric peen is intended to work the metal without marring the surface and is not intended to deliver a forceful impact, thus the typical ball peen will have a cylindrical peen on the opposite face of the hammer and the cylindrical peen can be used to deliver forceful blows such as are required when loosening bolts in a vehicle frame. As noted above, the cylindrical flat surface and the true ball peen surface have a tendency to slide off the target area when significant force is applied. When used for loosening bolts in a vehicle much time and energy is wasted returning to the same bolt because of such slippage.

### SUMMARY OF THE INVENTION

A general object of the invention is to allow for concentrated controlled impact to the work surface. The hammer can be used for any application requiring a concentrated, controllable impact or force including the assembly or disassembly of close tolerance or oxidized, rusted components. Although a tapered tool may be used to perform these tasks, the additional mass of the modified hemispheric contact face allows for a more concentrated, higher force impact.

### BRIEF DESCRIPTION OF THE DRAWINGS

Referring to the drawings which are appended hereto and which form a portion of this disclosure, it may be seen that:

FIG. 1 is an side elevational view of a first embodiment;

FIG. 2 is a perspective view of the first embodiment;

FIG. 3 is a perspective view of a second embodiment; and,

FIG. 4 is a side elevational view of the second embodiment.

### DETAILED DESCRIPTION

One or more of the above objects can be achieved, at least in part, by providing a large mass adjacent a flattened striking face in an air hammer tool.

Referring to the figures for a clearer understanding of the invention, note that the tool is a machined forging that is hardened to produce a durable impact surface. Tool 10 is designed with a standard 401 shank size such that it will fit most standard air hammers in use in most locations. A shank 11 flares to collar 12, which is also substantially standard with respect to most air hammer tools. Beyond the shank 12 the body 13 of the tool extends to mate with the enlarged head 14. In the illustrated embodiments the tool flares following a 0.375 inch radius to the widest part of the head where an annulus 16 of about 0.30 width is formed. A hemispherical surface 17 extends from annulus 16 to a machined striking surface 18. Striking surface 18 is approximately 0.186 inches in diameter, however other sizes may be used without departing from the teachings of this invention. The machined flat tip surface 18 of the ball peen shape allows the user to control the hammer with a reduction in slippage on the designated point of the work surface.

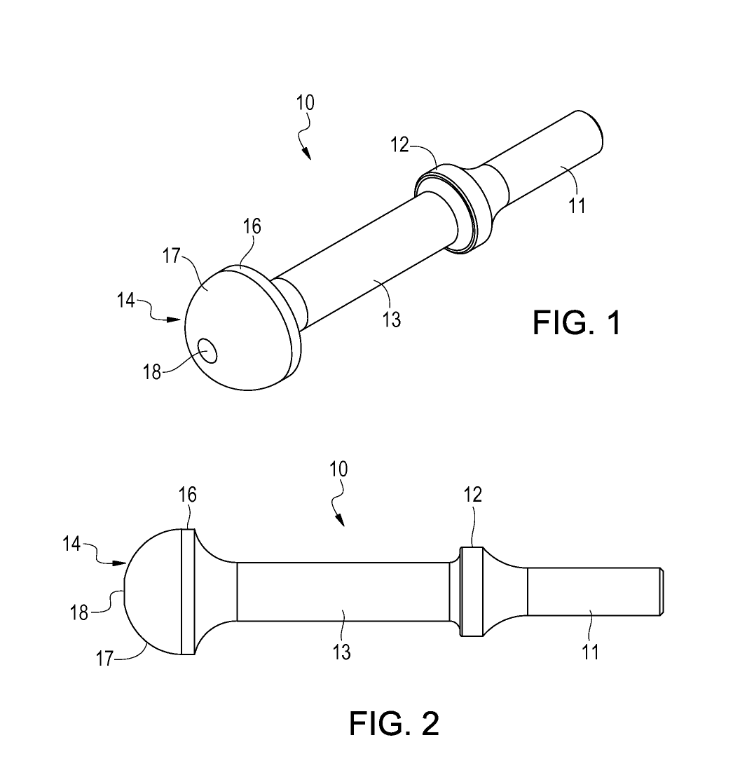

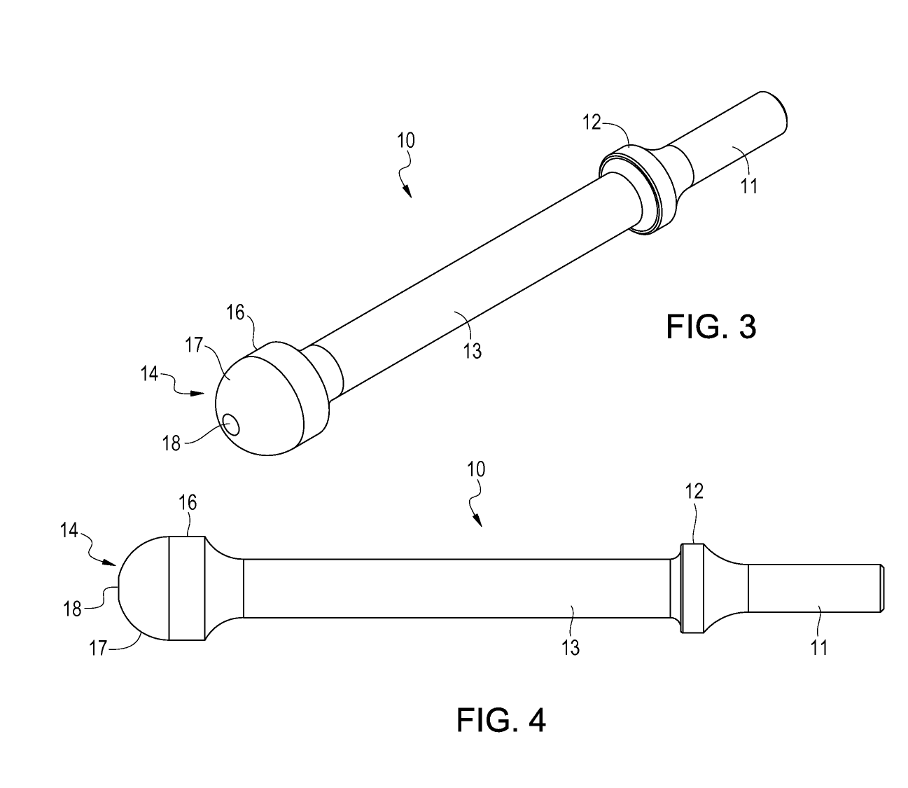

In the embodiment shown in FIGS. 1 and 2, the tool length is about 4.56 inches, whereas in the embodiment shown in FIGS. 3 and 4 the tool length is about 6.49 inches. In these embodiments a striking surface may vary from about 0.150 to about 0.210 in diameter. It will be understood that the enlarged head 14 provides additional mass to the tool when compared to a tool that simply tapers to the striking surface and that the embodiment of FIGS. 3 and 4 will also have increased mass.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A tool for an air hammer having an extended shank on one end and a ball peen striking head forming a distal end.

2. The tool as defined in claim 1 wherein said ball peen striking head has a flat striking surface formed opposite said shank.

3. The tool as defined in claim 2 wherein said flat striking surface is machined on said ball peen striking head and has a diameter of between about 0.150 and about 0.210 inches.

4. The tool as defined in claim 3 wherein said tool is machined forging and hardened.

5. The tool as defined in claim 1 wherein said tool has a length of between about 4.5 to about 6.5 inches.

6. The tool as defined in claim 5 wherein a flat striking surface is machined on said ball peen striking head and has a diameter of between about 0.150 and about 0.210 inches.

7. The tool as defined in claim 5 wherein said ball peen striking head has a flat striking surface formed opposite said shank.

8. The tool as defined in claim 1 wherein said shank has a first end insertable into an air hammer and flares to a collar between said first end and said head, said collar tapering to a cylindrical tool body intermediate said collar and said head and flaring radially at said head.

9. The tool as defined in claim 8 wherein said ball peen striking head has a flat striking surface formed opposite said shank.

10. The tool as defined in claim 8 wherein a flat striking surface is machined on said ball peen striking head and has a diameter of between about 0.150 and about 0.210 inches.

11. The tool as defined in claim 10 wherein said ball peen striking head has a diameter of about one inch.
